(19) United States
(12) Patent Application Publication
(10) Pub. No.: US 2009/0190381 A1
(43) Pub. Date: Jul. 30, 2009

(54) METHOD OF MODULATING POWER SUPPLY CONVERSION EFFICIENCY CURVE

(76) Inventor: Tsung-Chun CHEN, Taipei Hsien (TW)

Correspondence Address: Joe McKinney Muncy, PO Box 1364, Fairfax, VA, 22038-1364, US

(21) Appl. No.: 12/021,136

(22) Filed: Jan. 28, 2008

(51) Int. Cl. H02M 1/00

(52) U.S. Cl. 363/78

(57) ABSTRACT

The present invention discloses a method of modulating a power supply conversion curve. The method obtains an input power and an output power of the power supply device for a conversion efficiency curve, and obtains the best efficiency value in the conversion efficiency curve, and then obtains a total load using power outputted by the power supply device, in order to adjust the best efficiency value, such that the best efficiency value is directly proportional to the total load using power, and the power supply device is operated at the best conversion efficiency to achieve the energy saving effect.

### FIELD OF THE INVENTION

The present invention relates to a method of modulating a power supply conversion efficiency curve, and more particularly to a method of changing the output efficiency of a power supply device by adjusting working parameters by users.

### BACKGROUND OF THE INVENTION

Since the energy policy of different countries varies, most of the present power supply devices adopt a specification that maintains a ratio of an output power to input power (hereinafter referred to as “Efficiency”) over 80% when outputting 20%, 50% and 100% of the normal rated power in order to meet the requirements of a “80 PLUS” specification which is adopted by many countries. Therefore, the power supply devices produced by different manufacturers attempt to meet the foregoing specification and increase the efficiency to improve their market competitiveness. In the traditional designs of power supply devices, preset working parameters determine the best efficiency value of a working efficiency, such as a power supply device A complies with the “80 PLUS” specification, and the best efficiency value of the power supply device A outputs 50% of the normal rated power. If the power supply device A is operated at 60% of the normal rated power, the efficiency will reach its maximum, but if the output is over or below 60% of the normal rated output, only 80% of the efficiency is maintained. If the power supply device A is applied in a normal light load condition (meaning that the output is lower than 60% of the normal rated power for a long time), the power supply device A can only maintain 80% of the efficiency, and the power supply device A cannot be operated at the best efficiency, which is a loss. Similarly, if the best efficiency value of the power supply device B outputs 40% of the normal rated power, and the power supply device B is applied to a normal heavy load condition (meaning that the output exceeds 40% of the normal rated power for a long time), the power supply device B can maintain the efficiency at 80% only. From the description above, different working parameters of the traditional designs of the power supply devices give different best efficiency values, and the best efficiency value is constant and will not vary with a load, and thus the efficiency of the power supply device cannot be maximized.

### SUMMARY OF THE INVENTION

In view of the foregoing shortcoming of the prior art that the aforementioned power supply device has a constant best efficiency value that cannot cope with adjustment for different loads, the present invention has a primary objective of overcoming the foregoing shortcomings and avoiding the deficiency by providing a method of changing working parameters of a power supply device to adjust the best efficiency value for different types of loads.

To achieve the foregoing objective, the present invention provides a method of modulating a power supply conversion curve, and the method comprises the steps of: obtaining an input power and an output power of a power supply device to obtain a conversion efficiency curve and the best efficiency value of the conversion efficiency curve; obtaining a total load using power outputted by the power supply device to adjust the best efficiency value, such that the best efficiency value is directly proportional to the total load using power, and the power supply device can operate at the best conversion efficiency and achieve the effect of saving energy.

### BRIEF DESCRIPTION OF THE DRAWINGS

FIG. 1 is a block diagram showing a procedure in accordance with the present invention;

FIG. 2 is a block diagram of the structure of in accordance with the present invention;

FIG. 3 is a conversion efficiency curve of the invention;

FIG. 4 is another conversion efficiency curve of the invention; and

FIG. 5 is a further conversion efficiency curve of the invention.

### DETAILED DESCRIPTION OF THE PREFERRED EMBODIMENTS

The technical contents of the invention will now be described in more detail hereinafter with reference to the accompanying drawings that show various embodiments of the invention.

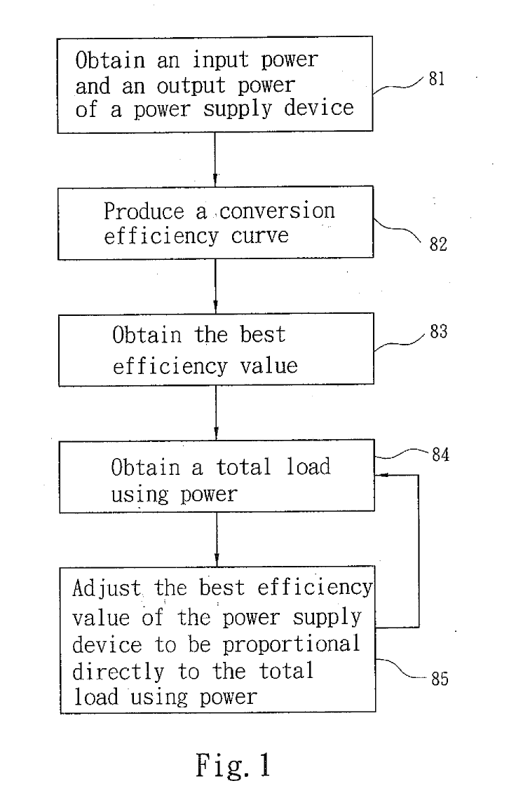

The present invention relates to a method of modulating a power supply conversion curve, and the method is applied for adjusting a conversion efficiency when the output power of a power supply device is used for driving a load, wherein the method comprises the steps of: (A) obtaining an input power and an output power of a power supply device, and forming a conversion efficiency curve by a power ratio of the input power to the output power; (B) obtaining the best efficiency value of the conversion efficiency curve; (C) obtaining a total load using power outputted by the power supply device; (D) adjusting the best efficiency value of the power supply device, such that the best efficiency value is directly proportional to the total load using power, and the power supply device operates with the total load using power to adjust the best efficiency value of the power supply device and operates at the best efficiency. Referring to FIG. 1 for the flow chart of a method in accordance with the present invention, the method obtains an input power and an output power of a power supply device 81, and produces a conversion efficiency curve 82 within the range of the normal rated output according to a power ratio of the input power to the output power, and obtains the best efficiency value 83 from the conversion efficiency curve, and then obtains a total load using power 84 of the power supply device to adjust the best efficiency value of the power supply device which is directly proportional to the total load using power 85, and keeps on adjusting the best efficiency value according to the change of the total load using power until the power supply device is operated at the best efficiency, and thus the power supply device is operated at the best efficiency to achieve the effect of saving energy.

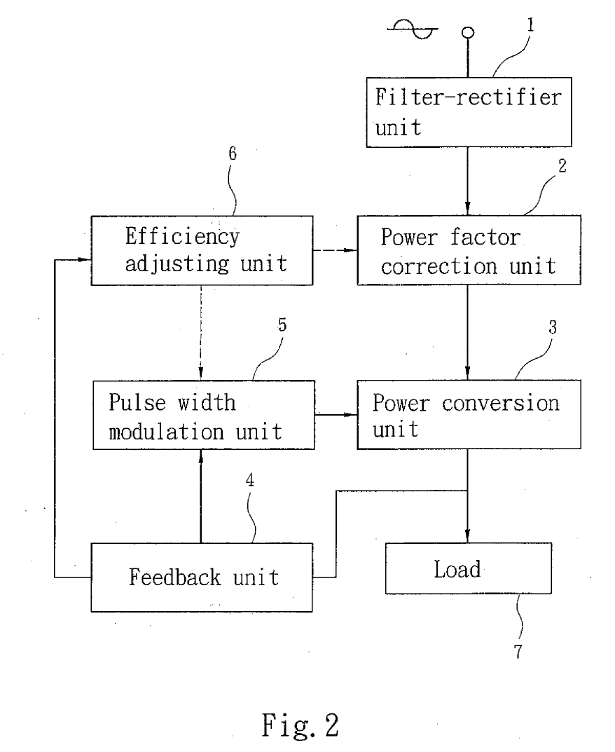

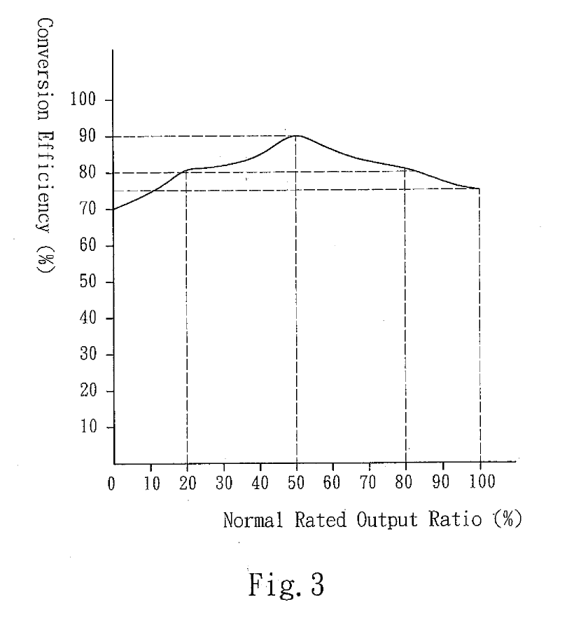

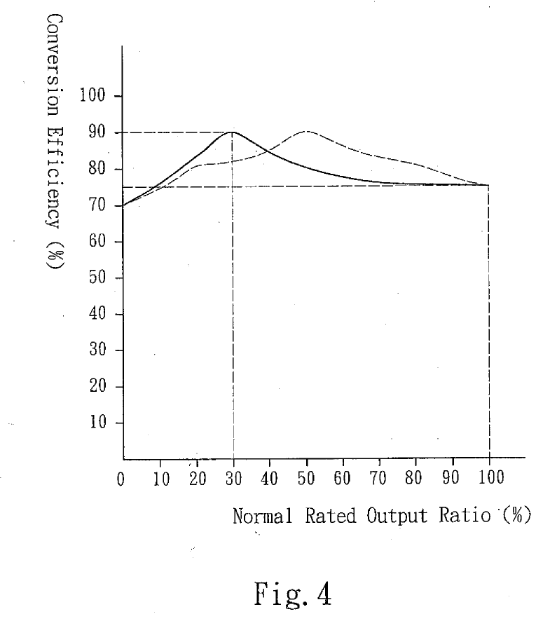

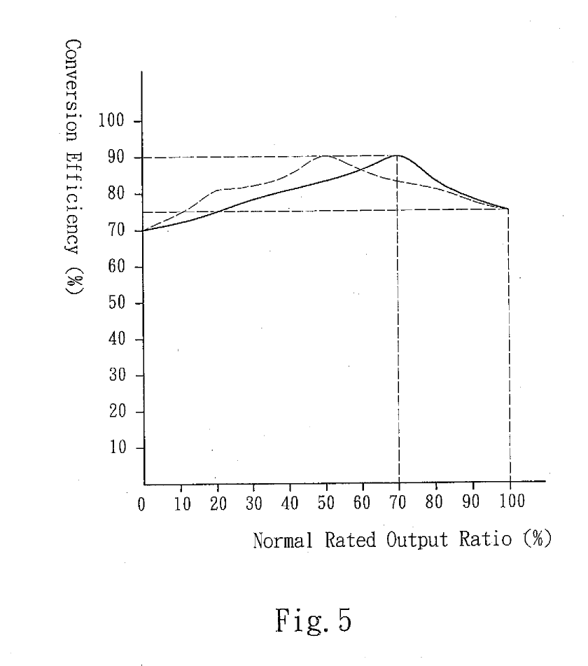

Referring to FIG. 2 for the structure of a power supply device in accordance to the method of the invention, the power supply device comprises a filter-rectifier unit 1, a power factor correction unit 2, a pulse width modulation unit 5, a power conversion unit 3 and a feedback unit 4, and the filter-rectifier unit 1 obtains, filters and rectifies the input power, and the power factor correction unit 2 determines a working power potential and adjust the input power to a working power according to the working power potential, and the pulse width modulation unit 5 generates a conducting periodic signal to drive the power conversion unit 3 to convert the working power into the output power for driving a load 7. When the power supply device drives the load 7, a conversion efficiency curve is formed by a power ratio of the input power to the output power, and the power supply device includes a feedback unit 4 for obtaining a feedback signal from the input power to determine the total load using power, and the power supply device further includes an efficiency adjusting unit 6 for obtaining the feedback signal and connecting to at least one of the power factor correction unit 2 and the pulse width modulation unit 5. The efficiency adjusting unit 6 is triggered to change a working power potential of the power factor correction unit 2, or change a conducting duration of the conducting periodic signal generated by the pulse width modulation unit 5 to change the conversion efficiency curve, when the load 7 is connected. The feedback unit 4 can adjust the conversion efficiency curve of the efficiency adjusting unit 6 according to the total load using power, such that the conversion efficiency curve is directly proportional to the total load using power, so as to adjust the conversion efficiency when the load 7 is connected and achieve the effect of controlling the best efficiency value of its conversion efficiency. Referring to FIGS. 3 to 5, FIG. 3 shows a conversion efficiency curve when the power supply device has not been adjusted. In the figures, the best efficiency value of the power supply device occurs when the output power is approximately equal to 50% of the normal rated output. Assumed that the normal rated output of the power supply device is 1000 W, the best efficiency is achieved at the output power of 500 W, but when the total load using power driven by the power supply device is 300 W, the efficiency adjusting unit 6 adjusts the power factor correction unit 2 or the pulse width modulation unit 5 according to the feedback signal to adjust the conversion efficiency curve, so that the best efficiency is directly proportional to the total load using power (as shown in FIG. 4), and the same applies to the total load using power for 700 W (as shown in FIG. 5), wherein the efficiency adjusting unit 6 can be connected to the power factor correction unit 2 or a rheostat of the pulse width modulation unit 5, or the efficiency adjusting unit 6 can be comprised of a sectional switch and a plurality of different impedances. The sectional switch can be triggered to switch connecting the plurality of different impedances to provide a variable impedance value. The circuit of the rheostat is a prior art, and thus will not be described here. The aforementioned structure uses different impedance values to affect the power factor correction unit 2 or the pulse width modulation unit 5 to change the conversion efficiency curve of the power supply device according to the load 7 to achieve the effects of operating the power supply device at the best efficiency value and saving energy.

While the invention has been described by means of specific embodiments, numerous modifications and variations could be made thereto by those skilled in the art without departing from the scope and spirit of the invention set forth in the claims.

What is claimed is:

1. A method of modulating a power supply conversion curve, comprising:
A. obtaining an input power and an output power of a power supply device, and forming a conversion efficiency curve by a power ratio of the input power and the output power;
B. obtaining the best efficiency value of said conversion efficiency curve;
C. obtaining a total load using power of said power supply device;
D. adjusting the best efficiency value of said power supply device, such that the best efficiency value is directly proportional to the total load using power.

2. The method of modulating the power supply conversion curve of claim 1, wherein said the power supply device implementing the method comprises a power factor correction unit for modulating the input power into a working power, a pulse width modulation unit for generating a conducting periodic signal, and a power conversion unit driven by said conducting periodic signal for converting the working power into the output power.

3. The method of modulating the power supply conversion curve of claim 2, wherein said power factor correction unit of said power supply device determines a working power potential to modulate the input power into the working power, and said power factor correction unit is connected to an efficiency adjusting unit for determining the working power potential.

4. The method of modulating the power supply conversion curve of claim 3, wherein said efficiency adjusting unit is a rheostat.

5. The method of modulating the power supply conversion curve of claim 3, wherein said efficiency adjusting unit is comprised of a sectional switch and a plurality of different impedances, such that said sectional switch can be triggered to switch connecting said plurality of different impedances to provide a variable impedance value.

6. The method of modulating the power supply conversion curve of claim 2, wherein said pulse width modulation unit of said power supply device is coupled to an efficiency adjusting unit for determining a conducting duration of said conducting periodic signal.

7. The method of modulating the power supply conversion curve of claim 6, wherein said efficiency adjusting unit is a rheostat.

8. The method of modulating the power supply conversion curve of claim 6, wherein said efficiency adjusting unit is comprised of a sectional switch and a plurality of different impedances, and said sectional switch can be triggered to switch connecting said plurality of different impedances and provide a variable impedance value.
